(19) United States
(12) Patent Application Publication
(10) Pub. No.: US 2022/0350201 A1
(43) Pub. Date: Nov. 3, 2022

(54) SURFACE LIGHT SOURCE DEVICE, AND DISPLAY DEVICE

(71) Applicant: Enplas Corporation, Saitama (JP)

(72) Inventors: Tomohiro SAITO, Saitama (JP); Hiroshi TAKATORI, Saitama (JP); Takuro MOMOI, Saitama (JP)

(73) Assignee: Enplas Corporation, Saitama (JP)

(21) Appl. No.: 17/242,537

(22) Filed: Apr. 28, 2021

(51) Int. Cl. G02F 1/13357

(52) U.S. Cl. CPC G02F 1/133606; G02F 1/133603

(57) ABSTRACT

A surface light source device includes a light-emitting device; and a light diffusion plate disposed over the light-emitting device. The light-emitting device includes a substrate, a plurality of light-emitting elements disposed on the substrate, and a sealing material disposed on the substrate and configured to seal the plurality of light-emitting elements, the sealing material being made of silicone or epoxy resin. The sealing material includes particles, the particles being optically transparent.

### TECHNICAL FIELD

The present invention relates to a surface light source device and a display device.

### BACKGROUND ART

In recent years, direct-surface light source devices including a plurality of light-emitting elements as a light source are used in transmissive image display devices such as liquid crystal display devices. In addition, in direct-surface light source devices, a large number of light-emitting elements are often disposed for the purpose of light irradiation over a wide range (see, for example, PTL 1).

PTL 1 discloses a direct-planar backlight module including a mini-LED substrate, a plurality of mini-LEDs disposed on the mini-LED substrate, and a fluorescence film disposed across the plurality of mini-LEDs. A plurality of recesses is formed in the surface of the fluorescence film opposite the mini-LED substrate. The light emitted from the mini-LED is mixed by the recesses when it is transmitted through the fluorescence film, and thus the light is uniformly emitted from the fluorescence film.

### CITATION LIST

### Patent Literature

PTL 1

U.S. Patent Application Publication No. 2019-0361294

### SUMMARY OF INVENTION

### Technical Problem

In the planar backlight module (surface light source device) disclosed in PTL 1, however, the region between adjacent mini-LEDs disadvantageously becomes dark. As such, there is a room for improvement in luminance distribution in the known surface light source devices.

An object of the present invention is to provide a surface light source device that can suppress luminance unevenness. In addition, another object of the present invention is to provide a display device including the surface light source device.

### Solution to Problem

A surface light source device according to an embodiment of the present invention includes a light-emitting device; and a light diffusion plate disposed over the light-emitting device. The light-emitting device includes a substrate, a plurality of light-emitting elements disposed on the substrate, and a sealing material disposed on the substrate and configured to seal the plurality of light-emitting elements, the sealing material being made of silicone or epoxy resin. The sealing material includes particles, the particles being optically transparent.

A display device according to an embodiment of the present invention includes the above-described surface light source device, and a display member configured to be irradiated with light emitted from the surface light source device.

### Advantageous Effects of Invention

According to the present invention, a surface light source device that suppresses the luminance unevenness can be provided.

### BRIEF DESCRIPTION OF DRAWINGS

FIG. 1A is a plan view of a surface light source device according to an embodiment of the present invention, and FIG. 1B is a front view;

FIG. 2A is a sectional view taken along line A-A of FIG. 1B, and FIG. 2B is a sectional view taken along line B-B of FIG. 1A;

FIG. 3 is a partially enlarged sectional view of FIG. 2B;

FIG. 4A is a partially enlarged plan view of the surface light source device for describing simulation conditions of the luminance distribution, and FIG. 4B is a partially enlarged sectional view taken along line A-A of FIG. 4A;

FIG. 5A is a graph illustrating a luminance distribution of a surface light source device including a sealing material including no particles of a comparative example, and FIG. 5B is a graph illustrating a result obtained by normalizing FIG. 5A;

FIG. 6A is a graph illustrating a luminance distribution in a surface light source device including a sealing material including 2wt % of silicone particles with an average particle diameter of 2 μm, and FIG. 6B is a graph illustrating a result obtained by normalizing FIG. 6A;

FIG. 7A is a graph illustrating a luminance distribution in a surface light source device including a sealing material including a sealing material including 2 wt % of silicone particles with an average particle diameter of 10 μm, and FIG. 7B is a graph illustrating a result obtained by normalizing FIG. 7A;

FIG. 8 is a graph illustrating a relationship between a distance between a front side surface of a substrate and a rear side surface of a light diffusion plate and a ratio of the minimum luminance between light-emitting elements with respect to the maximum luminance;

FIG. 9A is a graph illustrating a luminance distribution in a surface light source device in a case where the average particle diameter of the silicone particles is 0.7 μm, and FIG. 9B is a graph illustrating a luminance distribution in a surface light source device in a case where the average particle diameter of the silicone particles is 2.0 μm;

FIG. 10A is a graph illustrating a luminance distribution in a surface light source device in a case where the average particle diameter of the silicone particles is 4.5 μm, and FIG. 10B is a graph illustrating a luminance distribution in a surface light source device in a case where the average particle diameter of the silicone particles is 7.0 μm;

FIG. 11 is a graph illustrating a luminance distribution in a surface light source device in a case where the average particle diameter of the silicone particles is 10.0 μm; and

FIG. 12 is a graph illustrating a relationship between the percentage of the particles in a sealing material and a ratio of the minimum luminance between light-emitting elements with respect to the maximum luminance.

### DESCRIPTION OF EMBODIMENTS

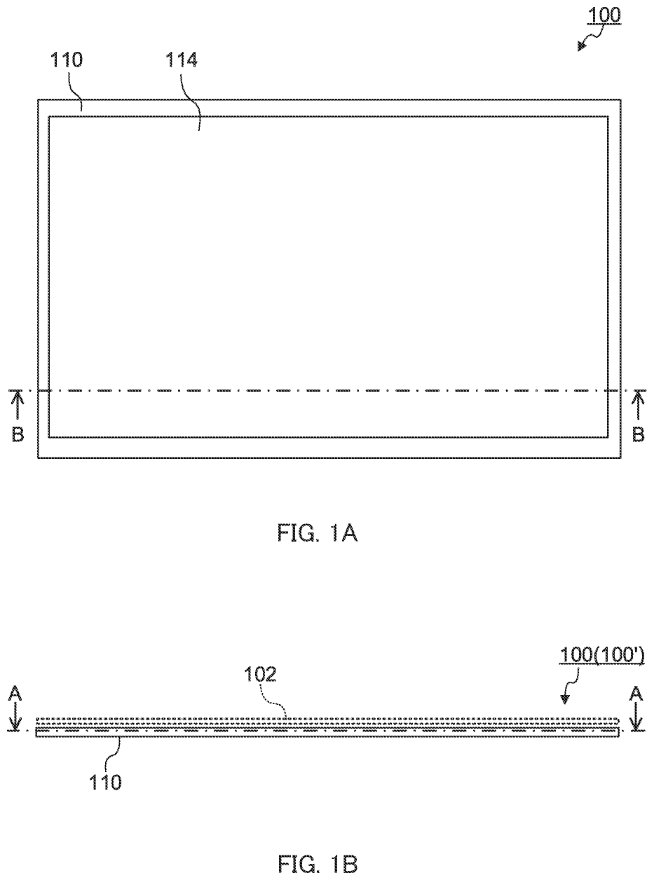

An embodiment of the present invention is elaborated below with reference to the accompanying drawings. In the following description, a surface light source device suitable for a backlight of a liquid crystal display device and the like is described as a typical example of a surface light source device according to an embodiment of the present invention. These surface light source devices can be used as display device 100′ (see FIG. 1B) when combined with display member 102 (e.g., a liquid crystal panel) configured to be irradiated with light from the surface light source device.

Configuration of Surface Light Source Device and Light-Emitting Device

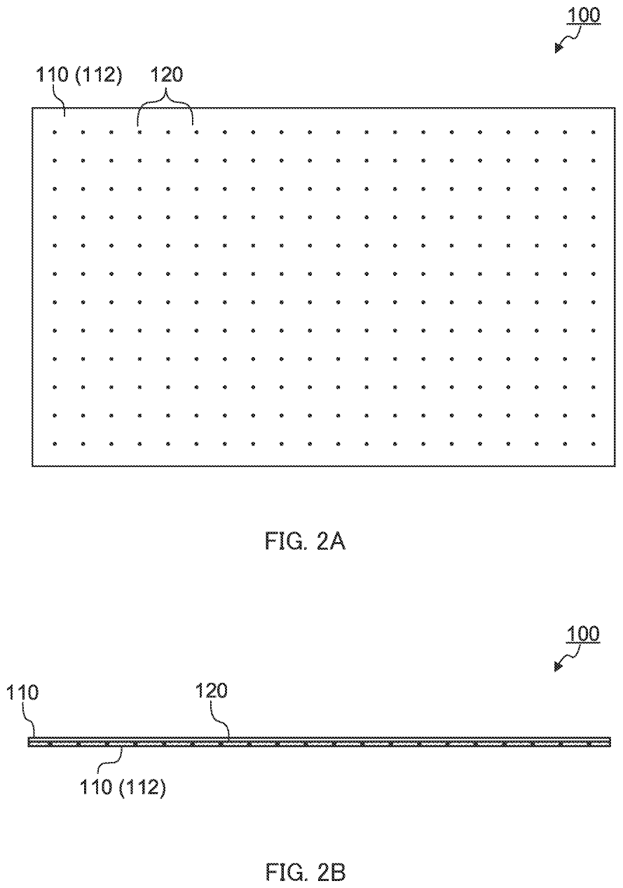

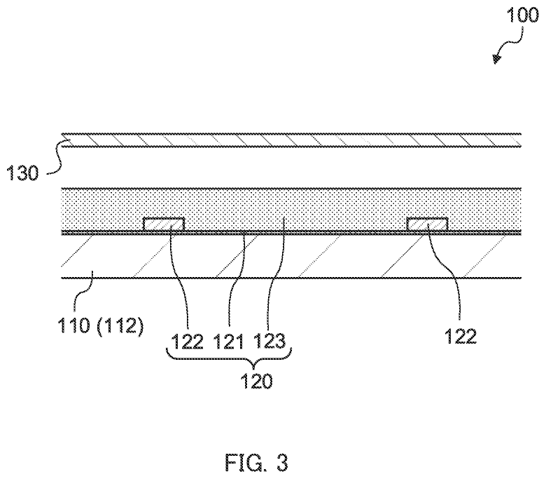

FIGS. 1A and 1B illustrate a configuration of surface light source device 100 according to an embodiment of the present invention. FIG. 1A is a plan view, and FIG. 1B is a front view. FIG. 2A is a sectional view taken along line A-A of FIG. 1B, and FIG. 2B is a sectional view taken along line B-B of FIG. 1A. FIG. 3 is a partially enlarged sectional view of FIG. 2B.

As illustrated in FIGS. 1A to 3, surface light source device 100 according to the present embodiment includes housing 110, light-emitting device 120, and light diffusion plate 130. Top plate 114 of housing 110 is provided with an opening. Light diffusion plate 130, which is disposed to close the opening, functions as a light-emitting surface. For example, the size of light-emitting surface is, but not limited to, approximately 400 mm×approximately 700 mm.

As illustrated in FIG. 3, in the present embodiment, light-emitting device 120 is fixed on bottom plate 112. Light-emitting device 120 includes substrate 121, a plurality of light-emitting elements 122, and sealing material 123.

Substrate 121, on which the plurality of light-emitting elements 122 and sealing material 123 are disposed, reflects, toward light diffusion plate 130, light emitted from light-emitting element 122 that reaches the surface of substrate 121. The surface of substrate 121 may function as a diffusive reflection surface. In addition, a reflection sheet may be disposed between substrate 121, and light-emitting element 122 and sealing material 123 such that the light emitted from light-emitting element 122 is reflected by the reflection sheet toward light diffusion plate 130. In the present embodiment, the light emitted from light-emitting element 122 is diffused and reflected at the surface of substrate 121 toward light diffusion plate 130.

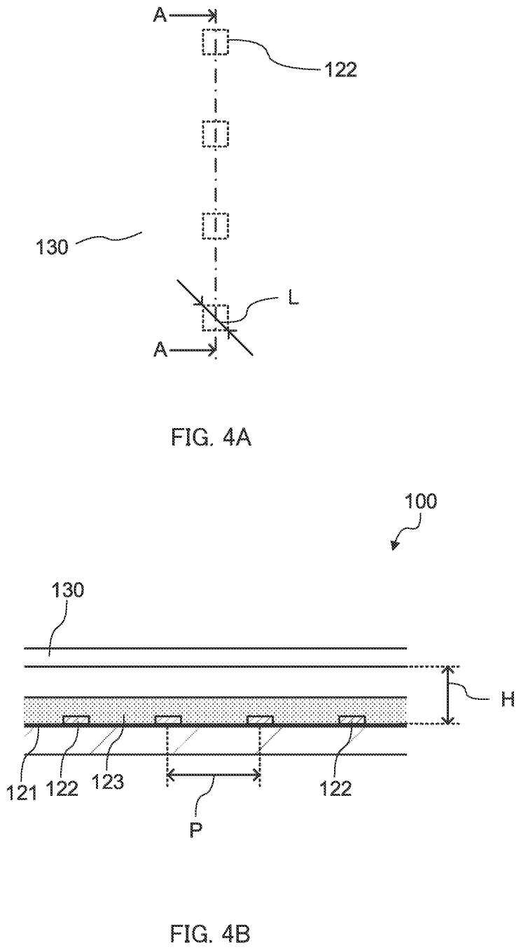

Distance H between the front side surface of substrate 121 and the rear side surface of light diffusion plate 130 (see FIG. 4B) is preferably 5 mm or smaller. In the present embodiment, luminance unevenness and chromaticity unevenness can be suppressed even when distance H between the front side surface of substrate 121 and the rear side surface of light diffusion plate 130 is 5 mm or smaller. For example, distance H between the front side surface of substrate 121 and the rear side surface of light diffusion plate 130 is 3 mm.

The plurality of light-emitting elements 122 is the light source of surface light source device 100, and mounted on substrate 121. Light-emitting element 122 is, for example, a light-emitting diode (LED) such as a blue light-emitting diode, a white light-emitting diode, and an RGB-light-emitting diode. In the present embodiment, light-emitting element 122 emits blue light of a wavelength of 380 to 485 nm. In addition, while the type of light-emitting element 122 is not limited, light-emitting element 122 (e.g., a COB-type light-emitting diode) that emits light from the top surface and the side surface is favorably used in light-emitting device 120 according to the present embodiment.

Light-emitting element 122 may be disposed such that the center of its light-emitting surface (top surface) overlaps the grid point of the triangular lattice, or overlap the grid point of the square grid (matrix shape). In the present embodiment, light-emitting element 122 is disposed such that the center of its light-emitting surface overlaps the grid point of the square grid.

Center-to-center distance P of two light-emitting elements 122 adjacent to each other in the plurality of light-emitting elements 122 is, for example, 8 to 25 mm. Center-to-center distance P of two light-emitting elements 122 adjacent to each other in the plurality of light-emitting elements 122 is preferably 2 mm or greater. If the center-to-center distance P is small, the number of light-emitting elements 122 may increase, and the manufacturing cost may increase.

Preferably, center-to-center distance P (mm) of two light-emitting elements 122 adjacent to each other in the plurality of light-emitting elements 122 and distance H (mm) between the front side surface of substrate 121 and the rear side surface of light diffusion plate 130 satisfy H/P≤0.56, more preferably H/P≤0.28. This means that relative to center-to-center distance P of two light-emitting elements 122 adjacent to each other in the plurality of light-emitting elements 122, distance H between the front side surface of substrate 121 and the rear side surface of light diffusion plate 130 is sufficiently small (surface light source device 200 is thin). Note that if H/P≤0.56 is not satisfied, no dark point may be generated in the region between light-emitting elements 122 at the light-emitting surface of surface light source device 200 in the first place.

In the case where the light-emitting surface has a rectangular shape, the size of one side of the light-emitting surface (top surface) in plan view of light-emitting element 122 is preferably, but not limited to, 0.1 to 0.8 mm, more preferably 0.1 to 0.4 mm. In the present invention, the smaller the LED to be used, the more appropriate light distribution can be achieved, and surface light source device 100 with less chromaticity unevenness can be obtained. For example, the size of light-emitting element 122 in plan view is 0.2 mm×0.38 mm.

The shape of the top surface of light-emitting element 122 in plan view is not limited. Examples of the shape of the top surface of light-emitting element 122 in plan view include a polygonal shape and a circular shape. In the present embodiment, the shape of the top surface of light-emitting element 122 in plan view is a rectangular shape. Note that preferably, length L of the diagonal line on the light-emitting surface of light-emitting element 122 (see FIG. 4A) and center-to-center distance P of two light-emitting elements 122 adjacent to each other in the plurality of light-emitting elements 122 satisfy P/L≤45. In addition, preferably, length L of the diagonal line on the light-emitting surface of light-emitting element 122 and center-to-center distance P of two light-emitting elements 122 adjacent to each other in the plurality of light-emitting elements 122 satisfy P/L≥10. When length L of the diagonal line on the light-emitting surface of light-emitting element 122 and center-to-center distance P of two light-emitting elements 122 adjacent to each other in the plurality of light-emitting elements 122 do not satisfy the above-mentioned relationship, no dark point may be generated in the region between light-emitting elements 122 at the light-emitting surface of surface light source device 200 in the first place.

The thickness of light-emitting element 122 is not limited as long as it does not protrude from sealing material 123. Preferably, the thickness of light-emitting element 122 is 0.05 to 0.2 mm.

Sealing material 123 is disposed on substrate 121, and seals the plurality of light-emitting elements 122. Sealing material 123 expands the light emitted from light-emitting element 122 in the plane direction of substrate 121. Sealing material 123 is an optically transparent film made of silicone or epoxy resin in which optically transparent particles are dispersed. The thickness of sealing material 123 is not limited as long as it is greater than the thickness of light-emitting element 122, and is, preferably, 0.25 to 0.5 mm, for example. Here, “thickness of sealing material” is the distance between the front side surface of substrate 121 and the front side surface of sealing material 123. When the thickness of light-emitting element 122 is 0.05 to 0.2 mm, the distance between the top surface of light-emitting element 122 and the front side surface of sealing material 123 is 0.05 to 0.45 mm, for example.

The particles are dispersed inside sealing material 123, and configured to diffuse light. Examples of the optically transparent particles include silicone particles, silica particles, and melamine-formaldehyde condensation particles. Preferably, the particles are silicone particles from the viewpoint of heat stability and uniform dispersion in the silicone constituting sealing material 123. Preferably, the average particle diameter of the number of the particles is, but not limited to, 0.3 to 10 μm.

The percentage of particle 240 with respect to sealing material 123 is set in accordance with the average particle diameter of particle 240. In the case where the average particle diameter of particle 240 is 0.7 μm or smaller, the percentage of particle 240 with respect to sealing material 123 is preferably 0.5 to 10 wt %. In the case where the average particle diameter of particle 240 is 10 μm or greater, the percentage of particle 240 with respect to sealing material 123 is preferably 0.5 to 10.0 wt %. In the case where the average particle diameter of particle 240 is greater than 0.7 μm (more preferably 2.0 μm or greater) and smaller than 10 μm (more preferably 7.5 μm or smaller), the percentage of particle 240 with respect to sealing material 123 is preferably 0.5 to 4.0 wt %. Details will be described later.

Commercially available particles include, for example, silicone particles (TSR9500 average particle size 4.5 μm, XC99-A8808 average particle size 0.7 μm; Momentive Performance Materials Japan, LLC), melamine-formaldehyde condensation particles (S6 average particle size 0.4 μm; Nippon Shokubai Co. (S6, average particle size 0.4 μm; Nippon Shokubai Co., Ltd.), and silica particles (KE-P, average particle size 0.3 μm; Nippon Shokubai Co., Ltd.) are known.

Light diffusion plate 130 is an optically diffusible plate-shaped member, and transmits light emitted from light-emitting device 120 while diffusing the light. Normally, light diffusion plate 130 has substantially the same size as a display member such as a liquid crystal panel. For example, light diffusion plate 130 is formed using optically transparent resins such as polymethylmethacrylate (PMMA), polycarbonate (PC), polystyrene (PS), and styrene methyl methacrylate copolymerization resin (MS). To provide the optically diffusible property, minute irregularity may be formed in the surface of light diffusion plate 130, or a light diffuser such as beads may be dispersed inside light diffusion plate 130. Normally, light diffusion plate 130 has substantially the same size as a display member such as a liquid crystal panel.

In surface light source device 100 according to the present embodiment, the light emitted from each light-emitting element 122 is expanded by sealing material 123 so as to illuminate a wide range of light diffusion plate 130. The light emitted from sealing material 123 (light-emitting device 120) is further expanded by light diffusion plate 130. Thus, surface light source device 100 according to the present embodiment can uniformly illuminate a planar display member (e.g., a liquid crystal panel).

Luminance Distribution

Here, the luminance distribution in surface light source device 100 was examined. FIG. 4A is a partially enlarged plan view of the device for describing simulation conditions of the luminance distribution. FIG. 4B is a partially enlarged sectional view taken along line A-A of FIG. 4A.

In this simulation, light-emitting element 122 that emits light with a wavelength of 450 nm was used. The thickness of light-emitting element 122 was set to 0.08 to 0.15 mm. Center-to-center distance P of adjacent light-emitting elements 122 was set to 18 mm. In addition, only two light-emitting elements 122 at the center were turned on. The thickness of sealing material 123 was set to 0.3 mm. Distance H between the front side surface of substrate 121 and the rear side surface of light diffusion plate 130 was set to 3 mm, 5 mm, 10 mm or 15 mm. As the particles, silicone particles with an average particle diameter of 2 μm or 10 μm were used. As light diffusion plate 130, a plate in which minute irregularities for providing optically diffusing properties are not formed and light diffusers such as beads are not dispersed was used.

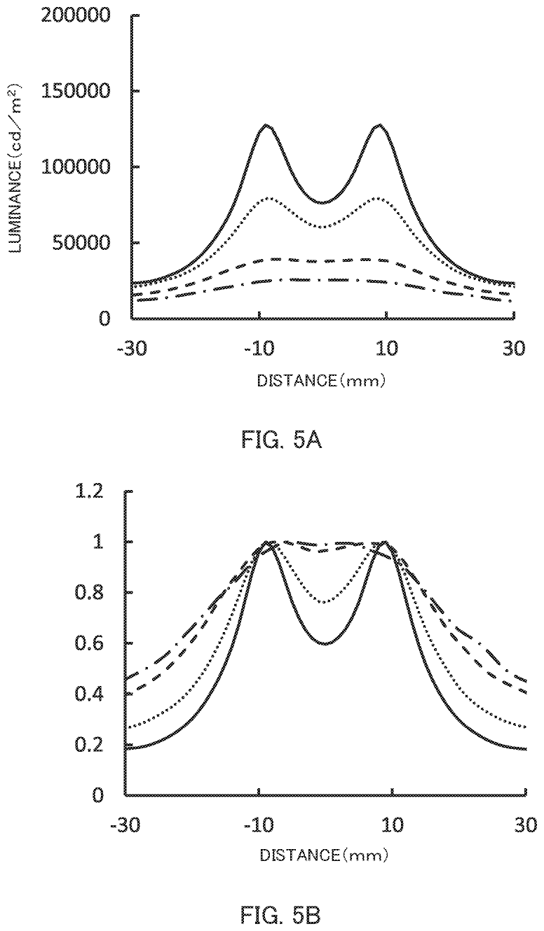

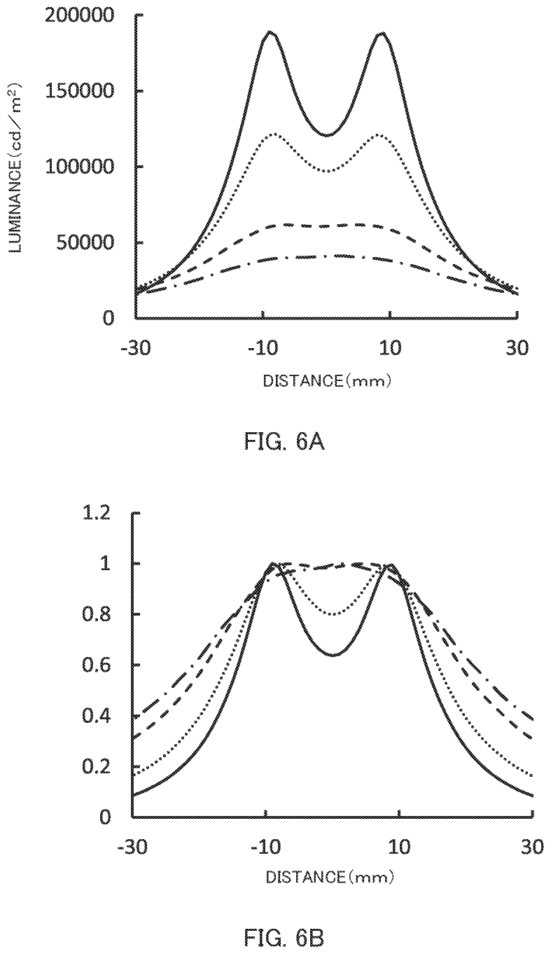

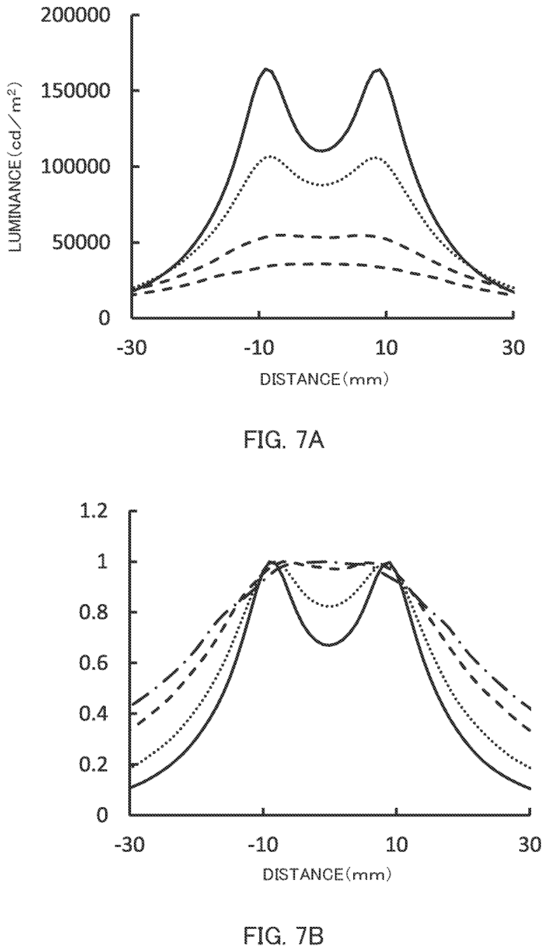

FIG. 5A is a graph illustrating a luminance distribution of a surface light source device including a sealing material including no particles of a comparative example. FIG. 5B is a graph illustrating a result obtained by normalizing FIG. 5A. FIG. 6A is a graph illustrating a luminance distribution in surface light source device 100 including sealing material 123 including 2 wt % of silicone particles with an average particle diameter of 2 μm. FIG. 6B is a graph illustrating a result obtained by normalizing FIG. 6A. FIG. 7A is a graph illustrating a luminance distribution in surface light source device 100 including a sealing material including 2 wt % of silicone particles with an average particle diameter of 10 μm. FIG. 7B is a graph illustrating a result obtained by normalizing FIG. 7A.

In FIGS. 5A to 7B, the solid line indicates a result of a case where H is 3 mm, the dotted line indicates a result of a case where H is 5 mm, the broken line indicates a result of a case where H is 10 mm, and the dashed line indicates a result of a case where H is 15 mm.

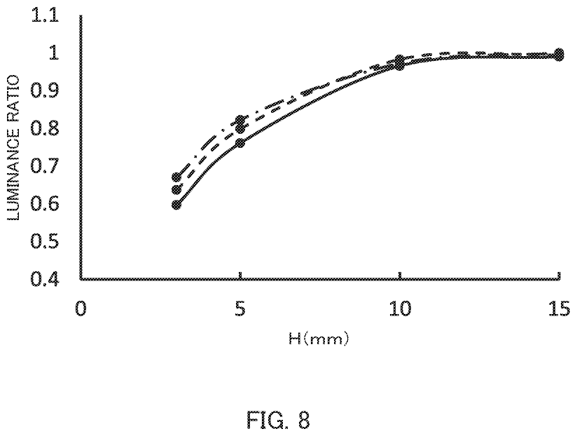

FIG. 8 is a graph illustrating a relationship between distance H (mm) between the front side surface of substrate 121 and the rear side surface of light diffusion plate 130 and the ratio of the minimum luminance between light-emitting elements 122 with respect to the maximum luminance. In FIG. 8, the abscissa indicates distance H (mm) between the front side surface of substrate 121 and the rear side surface of light diffusion plate 130. In FIG. 8, the ordinate indicates the ratio of the minimum luminance between light-emitting elements 122 with respect to the maximum luminance.

The solid line in FIG. 8 indicates a result obtained with a surface light source device of a comparative example including a sealing material including no particles. This result is obtained from the value of each curve of FIGS. 5A and 5B. The broken line in FIG. 8 indicates a result obtained with surface light source device 100 including sealing material 123 including 2 wt % of silicone particles with an average particle diameter of 2 μm. This result is obtained from the value of each curve of FIGS. 6A and 6B. The dashed line in FIG. 8 indicates a result obtained with surface light source device 100 including sealing material 123 including a sealing material including 2 wt % of silicone particles with an average particle diameter of 10 μm. This result is obtained from the value of each curve of FIGS. 7A and 7B.

As illustrated in FIGS. 5A, 6A and 7A, it was confirmed that the greater the distance H between the front side surface of substrate 121 and the rear side surface of light diffusion plate 130, the smaller the luminance value, regardless of the particle size. A possible reason for this is that since the distance H between the front side surface of substrate 121 and the rear side surface of light diffusion plate 130 increases, the quantity of light that reaches light diffusion plate 130 decreases. In addition, it can be seen that the luminance value increases when particles are added in the sealing material. A possible reason for this is that since the particles diffuse the light, the quantity of the light travelling toward light diffusion plate 130 was increased.

As illustrated in FIGS. 5B, 6B, 7B and 8, it was confirmed that when the distance H between the front side surface of substrate 121 and the rear side surface of light diffusion plate 130 is increased, the luminance unevenness is eliminated regardless of the particle size. A possible reason for this is that the distance H between the front side surface of substrate 121 and the rear side surface of light diffusion plate 130 is increased, and the quantity of the light that reaches the region between light-emitting elements 122 was relatively increased.

Next, the luminance distribution was examined when the percentage of the particles in sealing material 123 was changed. The average particle diameter of the silicone particles used was set to 0.7 μm, 2.0 μm, 4.5 μm, 7.0 μm, 10 μm, 15 μm, or 20 μm. The percentage of the particles with respect to sealing material 123 was set to 0 wt %, 0.5 wt %, 2 wt %, 5 wt %, or 10 wt %. Other conditions were the same as the above-mentioned conditions.

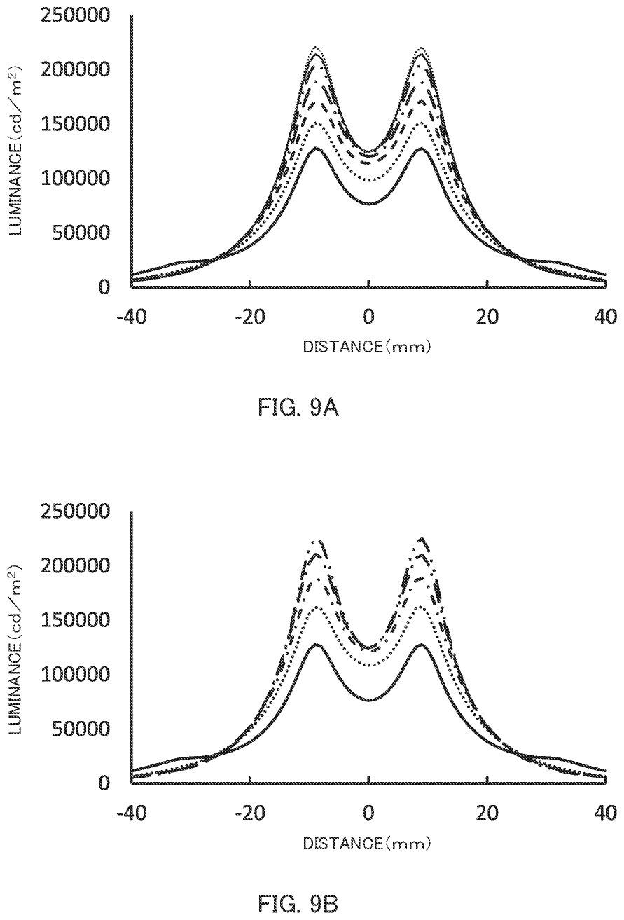

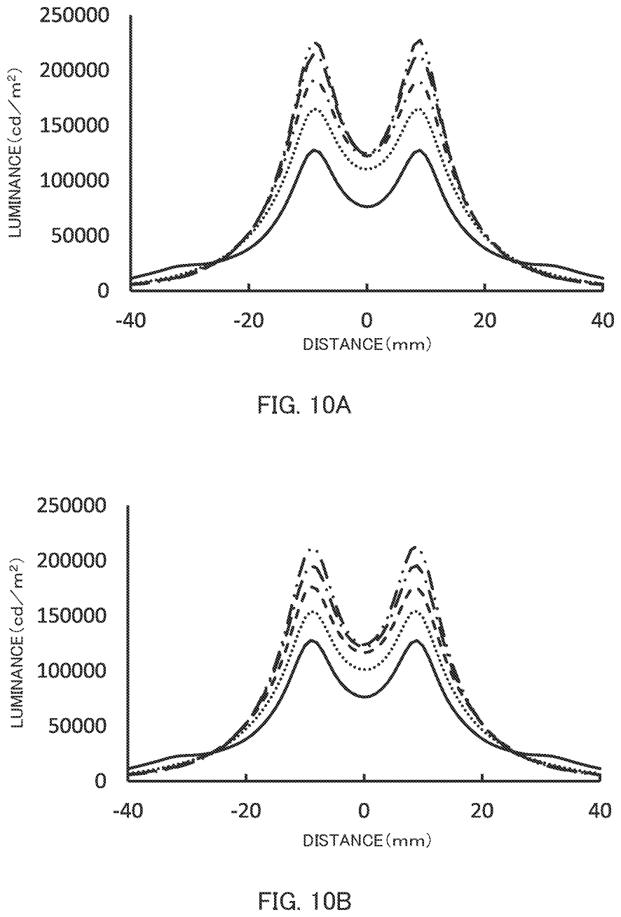

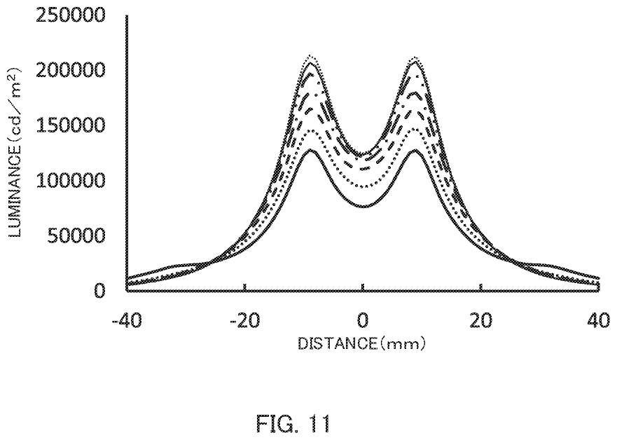

FIG. 9A is a graph illustrating the luminance distribution in surface light source device 100 in a case where the average particle diameter of the silicone particles is 0.7 μm. FIG. 9B is a graph illustrating the luminance distribution in surface light source device 100 in a case where the average particle diameter of the silicone particles is 2.0 μm. FIG. 10A is a graph illustrating the luminance distribution in surface light source device 100 in a case where the average particle diameter of the silicone particles is 4.5 μm. FIG. 10B is a graph illustrating the luminance distribution in surface light source device 100 in a case where the average particle diameter of the silicone particles is 7.0 μm. FIG. 11 is a graph illustrating the luminance distribution in surface light source device 100 in a case where the average particle diameter of the silicone particles is 10.0 μm.

In FIGS. 9A to 11, the solid line indicates a result obtained in the case where no particles are included. The dotted line indicates a result obtained in the case where the percentage of the particles is 0.5 wt %. The broken line indicates a result obtained in the case where the percentage of the particles is 2.0 wt %. The dashed line indicates a result obtained in the case where the percentage of the particles is 5.0 wt %. The chain double-dashed line indicates a result obtained in the case where the percentage of the particles is 10 wt %. In FIG. 9A and 11, the thin solid line indicates a result obtained in the case where the percentage of the particles is 15 wt %. In FIGS. 9A and 11, the thin dotted line indicates a result obtained in the case where the percentage of the particles is 20 wt %.

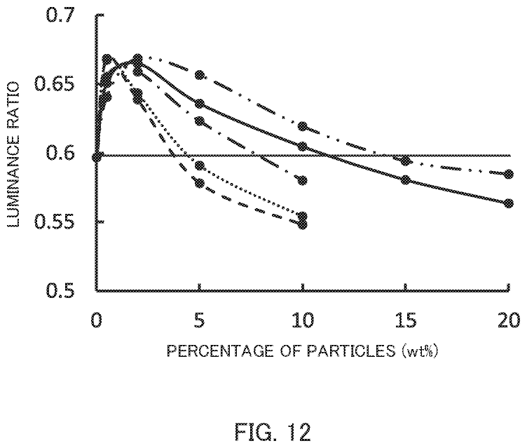

FIG. 12 is a graph illustrating a relationship between the percentage of the particles in sealing material 123 and the ratio of the minimum luminance between light-emitting elements 122 with respect to the maximum luminance (luminance ratio). In FIG. 12, the abscissa indicates the percentage of the particles in sealing material 123 (wt %). In FIG. 12, the ordinate indicates the ratio of the minimum luminance between light-emitting elements 122 with respect to the maximum luminance (luminance ratio).

The solid line in FIG. 12 indicates a result of a case where the average particle diameter of the particles is 0.7 μm. This result is obtained from the value of each curve of FIG. 9A. The dotted line in FIG. 12 indicates a result of a case where the average particle diameter of the particles is 2.0 μm. This result is obtained from the value of each curve of FIG. 9B. The broken line in FIG. 12 indicates a result of a case where the average particle diameter of the particles is 4.5 μm. This result is obtained from the value of each curve of FIG. 10A. The dashed line in FIG. 12 indicates a result of a case where the average particle diameter of the particles is 7.0 μm. This result is obtained from the value of each curve of FIG. 10B. The chain double-dashed line in FIG. 12 indicates a result of a case where the average particle diameter of the particles is 10 μm. This result is obtained from the value of each curve of FIG. 11.

Note that in this simulation, the case where the luminance ratio is greater than 0.6 was evaluated as passing (luminance unevenness was suppressed). As illustrated in FIGS. 9A to 12, in the case where the average particle diameter of the particles is 0.7 μm or smaller and the case where the average particle diameter of the particles is 10 μm or greater, the percentage of the particles with respect to sealing material 123 is preferably 0.5 to 10 wt %. In addition, in the case where the average particle diameter of the particles is greater than 0.7 μm and smaller than 10 μm (especially 2.0 to 7.5 μm), the percentage of the particles with respect to sealing material 123 is preferably 0.5 to 4 wt %.

Effect

As described above, in surface light source device 100 according to the present embodiment, sealing material 123 includes particles, and thus the light emitted from light-emitting element 122 is diffused by sealing material 123. Then, the light emitted from light-emitting device 120 is further diffused by light diffusion plate 130. Thus, the luminance unevenness can be eliminated.

Note that light-emitting device 120 may use bottom plate 112 of housing 110 as substrate 121. In this case, light-emitting device 120 includes bottom plate 112, light-emitting element 122, and sealing material 123. Light-emitting element 122 is disposed at bottom plate 112. In addition, the surface of bottom plate 112 may serve as a diffusive reflection surface, or a reflection sheet may be disposed at its surface such that the surface of the reflection sheet serves as a diffusive reflection surface.

### INDUSTRIAL APPLICABILITY

The surface light source device of the embodiment of the present invention is applicable to a backlight of a liquid crystal display device, a generally-used illumination device and the like, for example.

### Reference Signs List

100 Surface light source device
100′ Display device
102 Display member
110 Housing
112 Bottom plate
114 Top plate
120 Light-emitting device
121 Substrate
122 Light-emitting element
130 Light diffusion plate

1. A surface light source device comprising:
a light-emitting device; and
a light diffusion plate disposed over the light-emitting device,
wherein the light-emitting device includes a substrate, a plurality of light-emitting elements disposed on the substrate, and a sealing material disposed on the substrate and configured to seal the plurality of light-emitting elements, the sealing material being made of silicone or epoxy resin;
wherein the sealing material includes particles, the particles being optically transparent;
wherein an average particle diameter of the particles is greater than 0.7 μm and 7.5 μm or smaller; and
wherein a percentage of the particles with respect to the sealing material is 0.5 to 4.0 wt %.

2. The surface light source device according to claim 1,
wherein an average particle diameter of the particles is 0.7 μm or smaller; and
wherein a percentage of the particles with respect to the sealing material is 0.5 to 10 wt %.

3. The surface light source device according to claim 1,
wherein an average particle diameter of the particles is 10 μm or greater; and
wherein a percentage of the particles with respect to the sealing material is 0.5 to 10.0 wt %.

4. (canceled)

5. The surface light source device according to claim 1, wherein the particles are one or more types selected from silicone particles, silica particles, and melamine-formaldehyde condensation particles.

6. The surface light source device according to claim 1, wherein
H/P≤0.56 is satisfied, where P (mm) represents a center-to-center distance of two light-emitting elements adjacent to each other in the plurality of light-emitting elements, and H (mm) represents a distance between the substrate and the light diffusion plate.

7. The surface light source device according to claim 1, wherein a center-to-center distance P of two light-emitting elements adjacent to each other in the plurality of light-emitting elements is 2 mm or greater.

8. The surface light source device according to claim 1,
wherein the light-emitting element has a thickness of 0.05 to 0.2 mm; and
wherein the sealing material has a thickness of 0.25 to 0.5 mm.

9. The surface light source device according to claim 1,
wherein a light-emitting surface of the light-emitting element has a rectangular shape in plan view; and
wherein P/L≤45 is satisfied, where L (mm) represents a length of a longest diagonal line of the light-emitting surface, and P (mm) represents a center-to-center distance of two light-emitting elements adjacent to each other in the plurality of light-emitting elements.

10. The surface light source device according to claim 1,
wherein a light-emitting surface of the light-emitting element has a rectangular shape in plan view; and
wherein P/L≥10 is satisfied, where L (mm) represents a length of a longest diagonal line of the light-emitting surface, and P (mm) represents a center-to-center distance of two light-emitting elements adjacent to each other in the plurality of light-emitting elements.

11. A display device comprising:
the surface light source device according claim 1; and
a display member configured to be irradiated with light emitted from the surface light source device.
